(19) United States
(12) Patent Application Publication
(10) Pub. No.: US 2025/0196697 A1
(43) Pub. Date: Jun. 19, 2025

(54) CHARGING CONTROL DEVICE FOR AN ELECTRIC VEHICLE

(71) Applicant: TOYOTA JIDOSHA KABUSHIKI KAISHA, Toyota-shi Aichi-ken (JP)

(72) Inventor: Norihisa HOTTA, Nagoya-shi Aichi-ken (JP)

(73) Assignee: TOYOTA JIDOSHA KABUSHIKI KAISHA, Toyota-shi Aichi-ken (JP)

(21) Appl. No.: 18/983,851

(22) Filed: Dec. 17, 2024

(30) Foreign Application Priority Data
Dec. 19, 2023 (JP) 2023-214282

(51) Int. Cl. B60L 53/66; B60L 53/65; G06Q 30/04; G06V 20/62

(52) U.S. Cl. CPC B60L 53/665; B60L 53/65; G06Q 30/04; G06V 20/625; G06V 2201/08

(57) ABSTRACT

The vehicle identification unit identifies that a vehicle (electric vehicle) has parked in the parking space indicated by the parking space ID based on the captured image and parking space ID obtained from the camera. The charging control unit sets the charging device corresponding to the parking space to the authenticated state when the combination of the parking space ID of the parking space and the license plate number of the electric vehicle is included in the reservation information. The charging control unit causes the charging device to perform charging processing when the charging plug of the charging device in the authenticated state is connected to the electric vehicle. If the charging process unit does not receive a plug connection signal from the charging device within a predetermined time after the vehicle identification unit identifies that the electric vehicle has parked in the parking space, the charging device is de-authenticated.

### CROSS REFERENCE TO RELATED APPLICATION

This application claims priority to Japanese Patent Application No. 2023-214282 filed on Dec. 19, 2023, which is incorporated herein by reference in its entirety including the specification, claims, drawings, and abstract.

### TECHNICAL FIELD

The present disclosure relates to improvements to charging control device for an electric vehicle.

### BACKGROUND

Electric vehicles are known. The electric vehicles are vehicles that use electricity as an energy source and can be driven by the driving force of a motor. The electric vehicles include, for example, electric vehicles and hybrid vehicles.

In the past, a charging control device for an electric vehicle has been proposed to control charging of an electric vehicle. For example, Patent literature 1 discloses an electric power control system capable of timer charging, which starts charging an electric vehicle at a specified charging start time, and which informs the user if the charging plug is not connected to the electric vehicle a predetermined time before the charging start time. Patent literature 2 discloses a charging control system for electric vehicles which controls charging of an electric vehicle, checks the user's intention to charge the electric vehicle and the connection of the charging plug to the electric vehicle, and notifies the user when the user has the intention to charge the electric vehicle and the charging plug is not connected to the electric vehicle. A charging control device for electric vehicles is disclosed, which notifies the user when the user intends to charge the electric vehicle and when the charging plug is not connected to the electric vehicle.

### CITATION LIST

PATENT LITERATURE 1: JP2022-145087A
PATENT LITERATURE 2: JP2012-170181A

In the past, some car parks have been equipped with charging devices for charging electric vehicles, corresponding to the parking spaces. Generally, the owner of an electric vehicle charges the electric vehicle after being authorized by the charging device using a charging authorization card. However, a charging method, referred to herein as automatic authentication charging, has been proposed to enable owners of electric vehicles to charge their vehicles more easily. Automatic authentication charging is a method of charging as follows. First, user information is registered in advance, which is associated with the number of the electric vehicle and the billing address for the charging fee (e.g. the credit card number held by the owner of the electric vehicle in question). Next, the computer, such as a server, identifies the number of the electric vehicle parked in the parking space based on the captured image obtained by a camera taking a picture of the parking space. The computer then permits charging from the charging device corresponding to the parking space if the identified number is the number registered in the user information. According to automatic authorization charging, the owner of the electric vehicle can have the electric vehicle charged by the charging device corresponding to the parking space concerned without using a charging authorization card, simply by parking the electric vehicle in the designated parking space. The recharging fee is charged to the billing address registered in the user information.

A problem may arise with charging devices employing automatic authorized charging, where the owner of an electric vehicle parked in the parking space corresponding to the charging device may be unfairly charged for the charging fee. The problem is explained below with reference to FIG. 6.

FIG. 6 shows a plan view of a parking lot containing a plurality of parking spaces PS1 and PS2, with a charging device CE1 corresponding to parking space PS1 and a charging device CE2 corresponding to parking space PS2. First, an electric vehicle V1 with a number included in the registered user information parks in parking space PS1. The server S, which controls the charging devices CE1 and CE2, identifies the number of the electric vehicle V1 based on the captured image obtained by the camera taking a picture of the parking space PS1. Since the number of the electric vehicle V1 is included in the registered user information, the server S permits charging from the charging device CE1 corresponding to parking space PS1. In this specification, being allowed to charge the charging device is expressed as the charging device being authorized. The state in which charging is permitted to the charging device is also referred to as the authorized state. Here, the owner of the electric vehicle V1 may leave the parking space concerned without charging the electric vehicle V1 (for example, when the owner of the electric vehicle V1 uses the parking space PS1 as a mere parking space). In this case, the charging device CE1 will be left in the authorized state.

Suppose that another electric vehicle V2 is then parked in parking space PS2 in the vicinity of the charging device CE1. In this case, the owner of the electric vehicle V2 would be able to charge the electric vehicle V2 using the charging device CE1. The charging fee for such charging would then be charged to the billing address associated with the number of the electric vehicle V1 parked in the parking space PS1 corresponding to the charging device CE1 in the user information, i.e. to the owner of the electric vehicle V1.

The purpose of the charging control device for electric vehicle disclosed herein is to suppress the charging charge from being unjustly charged to the owner of the electric vehicle parked in the parking space corresponding to the charging device.

### SUMMARY

A charging control device for an electric vehicle disclosed in the present specification is being capable of accessing a memory in which user information is registered, wherein, in the user information, a registration number of an electric vehicle and information indicating a billing address of an owner of the electric vehicle are associated with each other, the charging control device comprising:
a vehicle identification unit that identifies that a vehicle has parked in a parking space and the registration number of the vehicle, based on a captured image obtained from a camera capturing an image of the parking space;
a charging control unit that causes a charging device to perform a charging process to charge an electric vehicle to which a charging plug is connected, when the registration number of the vehicle identified by the vehicle identification unit is registered in the user information and the charging plug of the charging device installed corresponding to the parking space is connected to the electric vehicle; and
a billing processing unit that performs a billing process to charge the owner of the electric vehicle with the registration number identified by the vehicle identification unit a charging fee for the charging process, based on the user information,
wherein the charging control unit does not cause the charging device to perform the charging process after a predetermined time has elapsed since the vehicle identification unit identified that the vehicle has parked in the parking space, even if the charging plug is connected to the electric vehicle.

The charging control device for electric vehicle may further comprising an authentication unit which authenticates an owner of an electric vehicle, wherein the charging control unit causes the charging device to perform the charging process in response to a request from the owner authenticated by the authentication unit, even after the predetermined time has elapsed since the vehicle identification unit identified that the vehicle has parked in the parking space.

According to the charging control device for electric vehicle disclosed herein, it is possible to prevent the owner of an electric vehicle parked in a parking space corresponding to the charging device from being improperly charged for the charging fee.

### BRIEF DESCRIPTION OF DRAWINGS

Embodiment of the present disclosure will be described based on the following figures, wherein:

FIG. 1 is configuration schematic of the charging control system for an electric vehicle;

FIG. 2 is schematic diagram of the configuration of the charging control server;

FIG. 3 is conceptual diagram showing examples of the contents of the user DB;

FIG. 4 is a conceptual diagram showing an example of the contents of reservation information;

FIG. 5 is a flowchart showing the processing flow of the charging control server;

FIG. 6 is a plan view of a parking lot with a plurality of parking spaces and a plurality of charging devices corresponding to each parking space.

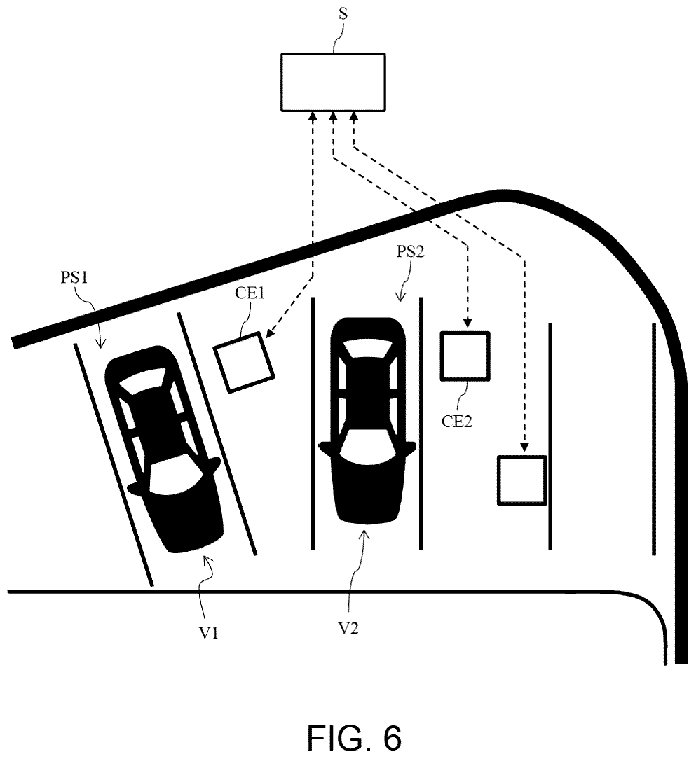

### EMBODIMENTS

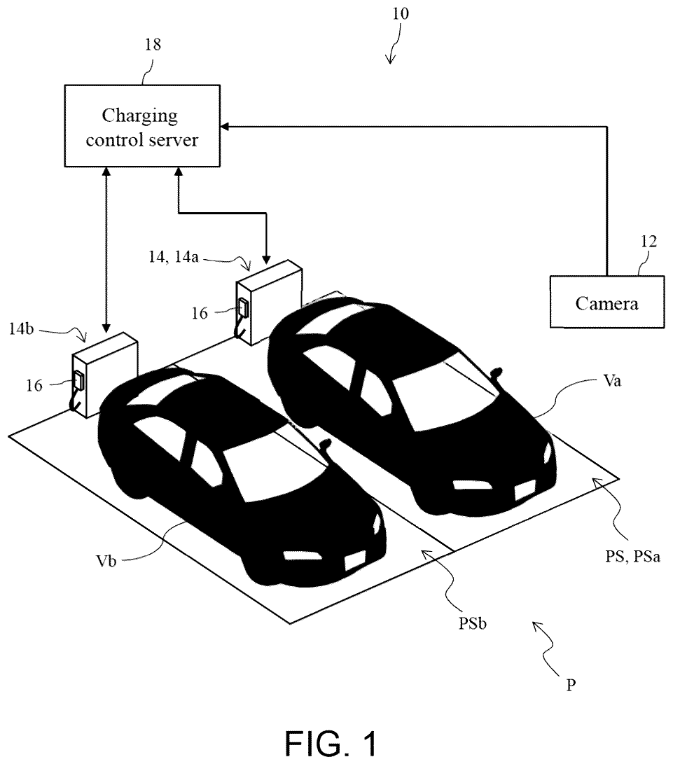

FIG. 1 shows a configuration schematic diagram of a charging control system 10 for electric vehicle. The charging control system 10 comprises a camera 12, a charging device 14, and a charging control server 18 as a charging control device for electric vehicles. The camera 12 and the charging control server 18, and the charging device 14 and the charging control server 18 are communicatively connected to each other.

Before describing the charging control system 10, the parking lot P where the camera 12 and the charging device 14 are installed will be described. The parking lot P is a parking lot for electric vehicles, so the vehicles parked in the parking space PS are electric vehicles. The parking lot P includes a plurality of parking spaces PS. FIG. 1 shows two parking spaces PSa and PSb adjacent to each other, but the parking lot P may have a greater number of parking spaces PS. In this embodiment, a reservation is required to use the parking lot P. A user who wishes to use parking space P registers user information, including the combination of the license plate number of the electric vehicle owned by the user and information indicating the billing address of the charging fee, with charging control server 18, and then makes a reservation in advance with the combination of parking space PS and the license plate number of the electric vehicle he/she wishes to park in said parking space PS. The parking space P can be used as a charging station for electric vehicles, but it can also be used for simple parking, not for charging purposes.

Camera 12 takes a picture of parking space PS. If an electric vehicle is parked in parking space PS, camera 12 will also photograph said electric vehicle. The camera 12 associates the acquired photographed image with a parking space ID that uniquely identifies the parking space PS to be photographed and transmits the image to the charging control server 18.

The charging device 14 is a device for charging an electric vehicle. The charging device 14 has a charging plug 16 that is connected to the electric vehicle. The charging device 14 is provided for each parking space PS. In the example in FIG. 1, each charging device 14 is installed in a corner of each parking space PS. FIG. 1 shows the charging device 14a corresponding to parking space PSa and the charging device 14b corresponding to parking space PSb. As described in detail below, the charging devices 14 are authorized by the charging control server 18 to charge the electric vehicle (i.e., they are set to the authorized state), and when the charging plug 16 is connected to the electric vehicle in the authorized state, the charging devices 14 start charging the said electric vehicle in accordance with the instructions of the charging control server 18.

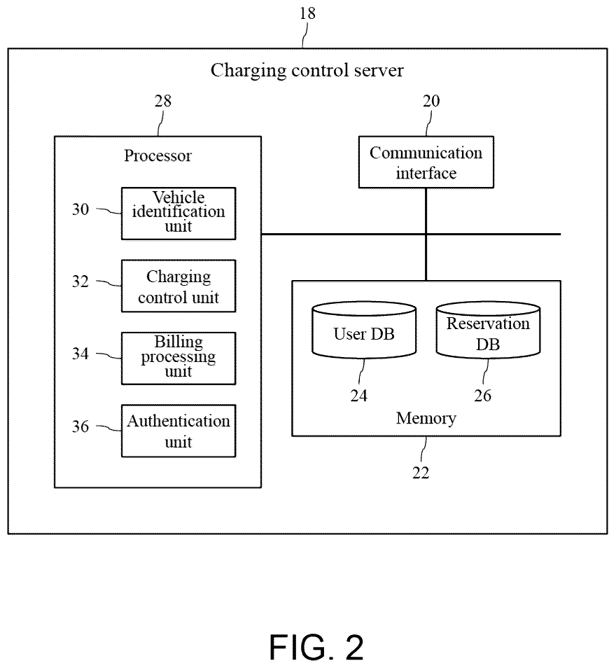

FIG. 2 is a schematic diagram of the charge control server 18. The charge control server 18 consists of a server computer, for example, but may be any device as long as it performs the functions described below. The functions of the charge control server 18 may be performed by multiple devices that are physically separated from each other.

The communication interface 20 comprises, for example, a network adapter. The communication interface 20 performs the function of communicating with the camera 12 and the charging device 14.

The memory 22 comprises a HDD (Hard Disk Drive), eMMC (embedded Multi Media Card), ROM (Read Only Memory) or RAM (Random Access Memory). The memory 22 stores a charging control program for electric vehicles to operate each part of the charging control server 18. The charging control program can be stored in a computer-readable, non-transitory storage medium, such as a USB (Universal Serial Bus) memory or SD card, for example. The charge control server 18 can read and execute the charge control program from such a storage medium. As shown in FIG. 2, the memory 22 stores a user DB (database) 24 and a reservation DB 26.

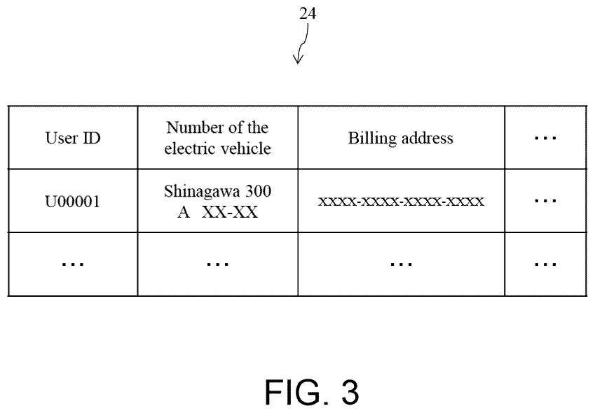

The user DB 24 stores user information concerning a user who has registered a user with the charge control server 18. FIG. 3 is a conceptual diagram showing an example of the contents of the user DB 24. The user information stored in the user DB 24 is information that associates a user ID that uniquely identifies the registered user, the number of the electric vehicle owned by the user, and information indicating the billing address of the user. The billing address of the user may be, for example, a credit card number.

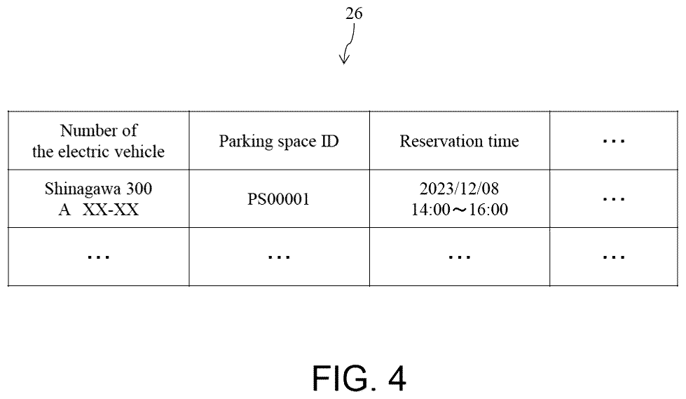

The reservation DB 26 stores reservation information related to reservations for use of parking spaces PS included in the parking lot P. FIG. 4 is a conceptual diagram showing an example of the contents of the reservation DB 26. The reservation information stored in the reservation DB 26 is information that associates the number of the electric vehicle using the parking space PS and the parking space ID of the parking space with each other. As shown in FIG. 4, the reservation information may further be associated with information indicating the reservation time. A user already registered with the charging control server 18 can make a reservation for use of a parking space PS by transmitting this information to the charging control server 18 from a user terminal (e.g., a smartphone or personal computer) used by the user. Upon receiving the reservation for use from the user, processor 28 registers the reservation information in the reservation DB 26. When the user has finished using the parking space PS pertaining to the reservation information, or when the reservation time included in the reservation information has expired, processor 28 deletes the reservation information from the reservation DB 26.

Processor 28 comprises, for example, a central processing unit (CPU). The processor 28 is communicatively connected to the communication interface 20 and the memory 22 via a data bus. The processor 28 functions as a vehicle identification unit 30, a charging control unit 32, a billing processing unit 34, and an authentication unit 36 by a vehicle charging control program stored in the memory 22.

The vehicle identification unit 30 identifies that a vehicle (in reality, an electric vehicle) has parked in the parking space PS indicated by the parking space ID based on the captured image acquired from the camera 12 and the parking space ID. The identification that a vehicle has parked in the parking space PS can be performed using known techniques (e.g., an object is detected in the captured image that is determined to be a vehicle in the parking space PS, and the difference in the position of the object in the captured images acquired at different times is less than a predetermined amount). Therefore, a detailed explanation is omitted here. The vehicle identification unit 30 identifies the license plate numbers of vehicles parked in the parking space PS. Since the identification of the license plate number of a vehicle based on the captured image can also be performed using known techniques (e.g., license plate detection process and character detection process, etc.), a detailed description is omitted here.

The charging control unit 32 performs the process of changing the authentication state of the charging device 14 and controlling the start and stop of charging from the charging device 14 to the electric vehicle. In this embodiment, the charging control unit 32 changes the authentication state of the charging device 14 corresponding to the parking space PS indicated by the parking space ID when the combination of the parking space ID obtained from the camera 12 and the vehicle number identified by the vehicle identification unit 30 is included in the reservation information stored in the reservation DB 26. In other words, the charging control unit 32 is responsible for the authentication of the charging device 14 corresponding to the parking space PS indicated by the parking space ID. In other words, the charging control unit 32 makes the charging device 14 corresponding to the reserved parking space PS authenticated when the electric vehicle pertaining to the reservation is parked in the reserved parking space PS. As described above, only users who have already registered with the charging control server 18 can make reservations for parking space PS, so the number of the electric vehicle included in the reservation information is the number of the electric vehicle included in the user information stored in the user DB 24. The charging control unit 32 maintains information identifying the authentication status of each charging device 14 in the memory 22.

When the reservation information includes information indicating the reservation time, the charging control unit 32 includes the combination of the parking space ID obtained from the camera 12 and the vehicle number identified by the vehicle identification unit 30 in the reservation information stored in the reservation DB 26, and that the vehicle has parked in the parking space PS The charging device 14 corresponding to the parking space PS indicated by the parking space ID may be set to the authenticated state when the time at which the vehicle identification unit 30 identifies that the vehicle has parked in the parking space PS is within the reservation time.

When the charging device 14 connects the charging plug 16 to the electric vehicle, the charging device 14 sends a plug connection signal to the charging control server 18 indicating that the charging plug 16 is connected to the electric vehicle. When the charging control unit 32 receives the plug connection signal from the charging device 14, it determines whether the charging device 14 is authenticated, and if it is, it causes the charging device 14 to perform a charging process to charge the electric vehicle. If the charging control unit 32 receives a plug connection signal from the charging device 14 and the charging device 14 is not in an authenticated state, the charging control unit 32 does not cause the charging device 14 to start the charging process for the electric vehicle.

After charging from the charging device 14 to the electric vehicle has started, when the storage capacity of the battery of the electric vehicle reaches a predetermined amount or when an instruction to stop charging is input to the charging device 14 from the user, the charging control unit 32 causes the charging device 14 to stop the charging process to the electric vehicle concerned.

When the charging process from the charging device 14 to the electric vehicle by the instruction of the charging control unit 32 is completed, the billing processing unit 34 identifies, based on the user DB 24, the billing destination associated with the license plate number of the electric vehicle parked in the parking space PS corresponding to the charging device 14 for which the charging control unit 32 had the charging process executed. The billing destination is the billing destination of the owner of the electric vehicle parked in the parking space PS, whose number is identified by the vehicle identification unit 30. The billing processing unit 34 then executes the billing process to charge the billing destination identified by the billing destination for the charging charge for the charging process in question.

Now, consider the case where the electric vehicle parked in the parking space PS and the electric vehicle to which the charging plug 16 of the charging device 14 corresponding to the parking space PS is connected are different from each other. For example, referring to FIG. 1, suppose that the combination of the parking space PSa and the number of the electric vehicle Va is included in the reservation information, and that the electric vehicle Va parked in the parking space PSa. In this case, the charging control unit 32 places the charging device 14a corresponding to the parking space PSa in an authenticated state. If another electric vehicle Vb were to park in parking space PSb and the owner of the electric vehicle Vb were to connect the charging plug 16 of the charging device 14a to the electric vehicle Vb, the charging control unit 32 would cause the charging device 14a to perform the charging process to charge the electric vehicle Vb. Then, the charging processing unit 34 charges the owner of the electric vehicle Va the charging fee for the charging process.

In this embodiment, in order to address the above problem, the charging control unit 32 does not allow the charging device 14a to perform the charging process (even if the charging plug 16 of the charging device 14a corresponding to that parking space PSa is connected to the electric vehicle) after a predetermined time has elapsed since the vehicle identification unit 30 identified that the vehicle (electric vehicle Va) has parked in the parking space PSa. In this embodiment, the charging control unit 32 deauthenticates the charging device 14a if it does not receive a plug connection signal from the charging device 14a within a predetermined time after the vehicle identification unit 30 identifies that the electric vehicle Va has parked in the parking space PSa.

As a result, even if the charging plug 16 of the charging device 14a is connected to another electric vehicle (e.g., electric vehicle Vb) after a predetermined time has elapsed after parking the electric vehicle Va in the parking space PSa, the charging device 14a will not perform the charging process. Therefore, the owner of the electric vehicle Va is prevented from being charged for the charging fee.

The predetermined time here may be set appropriately. For example, considering the case where the owner of the electric vehicle Va uses the charging device 14a to charge the electric vehicle Va by automatic authentication charging, the predetermined time may be set to be equivalent to the time required by the owner of the electric vehicle to connect the charging plug 16 of the charging device 14 corresponding to the parking space PS to the electric vehicle after the electric vehicle is parked in the parking space PS. The predetermined time may be set as a time equivalent to the time required for the owner of the electric vehicle to connect the charging plug 16 of the charging device 14 corresponding to the parking space PS to the electric vehicle.

After the predetermined time has elapsed after parking the electric vehicle Va in the parking space PSa, the electric vehicle Va cannot be charged from the charging device 14a by automatic authentication charging. Therefore, after a predetermined period of time has elapsed after parking the electric vehicle Va in the parking space PSa, the owner of the electric vehicle Va should be able to charge the electric vehicle Va from the charging device 14a by using a charging application that runs on a user terminal (such as a smartphone) that he/she uses. The owner of the electric vehicle Va can charge the electric vehicle Va from the charging device 14a by using a charging application running on a user terminal (e.g., a smartphone) used by the owner.

Specifically, first, the owner of the electric vehicle Va sends an authentication request to the charging control server 18 using the charging application, presenting a pre-registered user ID, after a predetermined time has elapsed since the vehicle identification unit 30 identified that the vehicle (electric vehicle Va) has parked in the parking space PSa. The authentication unit 36 of the charging control server 18 authenticates the owner of the electric vehicle Va by referring to the user DB 24. The owner of the electric vehicle Va then uses the charging application to send a charging permission request while specifying the charging device 14a. The charging control unit 32 places the charging device 14a in an authenticated state based on said charging permission request. When the charging plug 16 of the charging device 14a is connected to the electric vehicle Va and a plug connection signal is received from the charging device 14a, the charging control unit 32 causes the charging device 14a to perform the charging process for the electric vehicle Va. After the charging process from the charging device 14a to the electric vehicle Va is completed, the billing processing unit 34 executes the billing process to charge the charging fee for the charging process to the billing destination associated with the user ID of the owner authenticated by the authentication unit 36 based on the user DB 24.

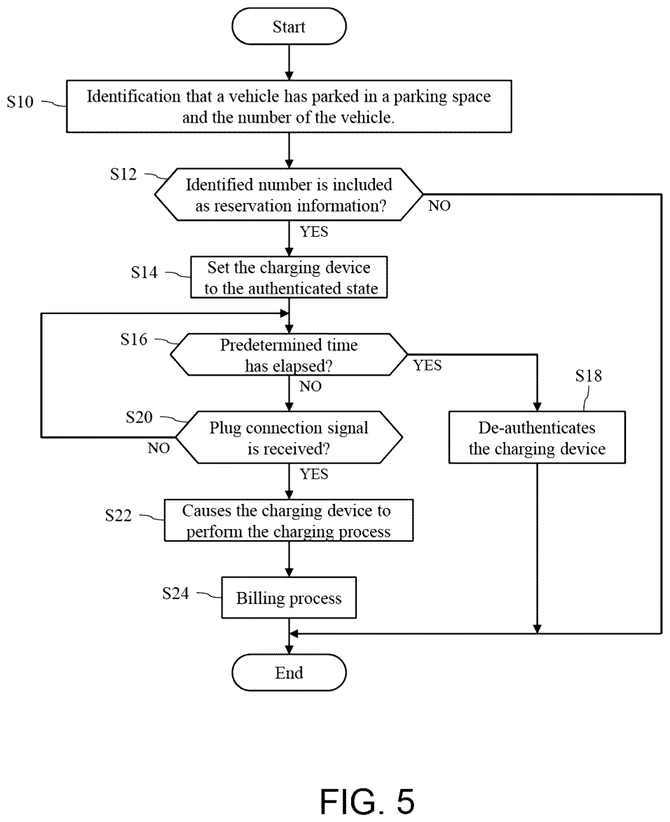

The outline of the charging control system 10 for this embodiment is as described above. The flowchart shown in FIG. 5 below describes the process flow of the charging control server 18 for this embodiment. Here, the case in which an electric vehicle Va is parked in parking space PSa in FIG. 1 will be used as an example.

In step S10, the vehicle identification unit 30 identifies that a vehicle (in reality, an electric vehicle Va) has parked in the parking space PS indicated by the parking space ID (in this case, parking space PSa) based on the captured image and parking space ID obtained from the camera 12, and the license number of the vehicle.

In step S12, the charging control unit 32 determines whether or not the combination of the parking space ID of the parking space PSa and the number of the identified electric vehicle Va obtained in step S10 is included as reservation information in the reservation DB 26. If the combination of the parking space ID of parking space PSa and the license plate number of the identified electric vehicle Va is not included in the reservation information, the process ends, and if it is included, the process proceeds to step S14.

In step S14, the charging control unit 32 sets the charging device 14a corresponding to the parking space PSa to the authenticated state.

In step S16, the charging control unit 32 determines whether a predetermined time has elapsed since the vehicle identification unit 30 identified that a vehicle parked in the parking space PSa in step S10. If the predetermined time has elapsed, it proceeds to step S18.

In step S18, the charging control unit 32 de-authenticates the charging device 14a. Thereafter, even if the charging plug 16 of the charging device 14A is connected to the electric vehicle, the charging device 14A will not charge said electric vehicle by automatic authentication charging.

If it is determined in step S16 that the predetermined time has not elapsed, the process proceeds to step S20.

In step S20, the charging control unit 32 determines whether a plug connection signal is received from the charging device 14a. If the charging plug 16 of the charging device 14a is connected to an electric vehicle (in this case, an electric vehicle Va is assumed) and a plug connection signal is received from the charging device 14a, then proceed to step S22. If the plug connection signal is not received from the charging device 14a, return to step S16.

In step S22, the charging control unit 32 determines whether the charging device 14a is in the authentication state, and since it is in the authentication state here, it causes the charging device 14a to perform the charging process to charge the electric vehicle Va.

In step S24, after completion of the charging process in step S22, the billing processing unit 34 executes a billing process in the user DB 24 to bill the billing destination associated with the number of the electric vehicle Va identified in step S10 for the charging charge for the charging process in step S22.

The above described embodiment of the charging control device for electric vehicles is not limited to the above embodiment, and various modifications are possible without departing from the intent thereof.

For example, in the above embodiment, the parking space P is reserved, and when the parking space ID of the parking space PS and the license plate number of the electric vehicle parked there are included in the reservation information, the charging device 14 corresponding to the parking space PS is set to an authenticated state, but the parking space P may not be reserved. In such a case, the charging device 14 corresponding to the parking space PS should be authenticated when the license plate number of the electric vehicle parked in the parking space PS is included in the user information stored in the user DB 24.

In the above embodiment, the charging device 14 and the charging control server 18 were separate devices, but the charging device 14 may perform the functions of the charging control server 18.

### REFERENCE SIGNS LIST

10 charging control system, 12 camera, 14 charging device, 16 charging plug, 18 charging control server, 20 communication interface, 22 memory, 24 user DB, 26 reservation DB, 28 processor, 30 vehicle identification unit, 32 charging control unit, 34 billing processing unit, 36 authentication unit

1. A charging control device for an electric vehicle, the charging control device being capable of accessing a memory in which user information is registered, wherein, in the user information, a registration number of an electric vehicle and information indicating a billing address of an owner of the electric vehicle are associated with each other, the charging control device comprising:
a vehicle identification unit that identifies that a vehicle has parked in a parking space and the registration number of the vehicle, based on a captured image obtained from a camera capturing an image of the parking space;
a charging control unit that causes a charging device to perform a charging process to charge an electric vehicle to which a charging plug is connected, when the registration number of the vehicle identified by the vehicle identification unit is registered in the user information and the charging plug of the charging device installed corresponding to the parking space is connected to the electric vehicle; and
a billing processing unit that performs a billing process to charge the owner of the electric vehicle with the registration number identified by the vehicle identification unit a charging fee for the charging process, based on the user information,
wherein the charging control unit does not cause the charging device to perform the charging process after a predetermined time has elapsed since the vehicle identification unit identified that the vehicle has parked in the parking space, even if the charging plug is connected to the electric vehicle.

2. The charging control device for electric vehicle according to claim 1, further comprising
an authentication unit which authenticates an owner of an electric vehicle, wherein
the charging control unit causes the charging device to perform the charging process in response to a request from the owner authenticated by the authentication unit, even after the predetermined time has elapsed since the vehicle identification unit identified that the vehicle has parked in the parking space.
